(19) United States
(12) Patent Application Publication
(10) Pub. No.: US 2010/0125684 A1
(43) Pub. Date: May 20, 2010

(54) Data Output System for Mobile Device and Data Output Method Thereof

(75) Inventor: Meng-Shu Lee, Hsinchu Hsien (TW)

Correspondence Address: EDELL, SHAPIRO & FINNAN, LLC, 1901 RESEARCH BOULEVARD, SUITE 400, ROCKVILLE, MD, 20850, US

(73) Assignee: MStar Semiconductor, Inc., Hsinchu Hsien (TW)

(21) Appl. No.: 12/618,864

(22) Filed: Nov. 16, 2009

(30) Foreign Application Priority Data
Nov. 19, 2008 (TW) 097144646

(51) Int. Cl. G06F 3/00

(52) U.S. Cl. 710/30; 710/1

(57) ABSTRACT

A data output system for a mobile device and an associated method for outputting data of a mobile device are provided. The data output system for a mobile device can deliver data output from the mobile device to an embedded system, and display the data on a display screen of the embedded system. When the data output system is implemented in a mobile phone, a navigation map of the mobile phone can be shown by a large screen of the embedded system, and the embedded system can be utilized as a phone interface.

### CROSS REFERENCE TO RELATED PATENT APPLICATION

This patent application is based on Taiwan, R.O.C. patent application No. 097144646 filed on Nov. 19, 2008.

### FIELD OF THE INVENTION

The present invention relates to a data output system and a data output method thereof, and more particularly, to a data output system for externally connecting to a mobile device to display output data of the mobile device, and an output method thereof.

### BACKGROUND OF THE INVENTION

Handheld mobile devices including cell phones and personal digital assistants (PDAs) are equipped with ever-growing powerful functions. These functions, which include making and receiving phone calls, accessing wireless internet, and navigation, are currently all integrated into one mobile device to conveniently provide a user with “on-the-go” services. In order to be portable and handy, mobile devices are manufactured as compact as possible; however, this trend also means a certain degree of restriction on the size of the display screen as a trade-off. While a standard small screen of a mobile phone may not be awkward to operate when a user is free to adjust the location of the mobile phone in front of one's eyes, the convenience of the mobile device may be greatly diminished by the rather small screen when a user is not able to freely adjust the location of the mobile phone, such as when driving. Likewise, the use of a larger screen might be much more desirable when viewing images or video files stored in the mobile device with other viewers.

Therefore, it would be desirable to provide a system and method that enables a user to deliver output data of a mobile device to a larger screen for display.

### SUMMARY OF THE INVENTION

Therefore, it is one object of the invention to provide a data output system and an output method thereof, which output data transmitted from a mobile device to an embedded system when the data output system is externally connected to the mobile device, and then display the output data on a display screen of the embedded system.

According to one embodiment of the invention, a data output system for externally connecting to a mobile device is disclosed. The data output system comprises an embedded system having an output module and a processing module. The output module, coupled to the processing module, processes digital data transmitted from the mobile device, and transmits the processed digital data to the output module for output.

According to one embodiment of the invention, a data output method for a mobile device is provided. The method comprises steps of transmitting digital data of the mobile device to an embedded system, processing the digital data using the embedded system, and outputting the processing digital data using an output device of the embedded system.

### BRIEF DESCRIPTION OF THE DRAWINGS

The present invention will become more readily apparent to those ordinarily skilled in the art after reviewing the following detailed description and accompanying drawings, in which:

FIG. 1 is a schematic diagram of a data output system according to one embodiment of the invention;

FIG. 2 is a schematic diagram of transmission between the mobile device and the embedded system in FIG. 1 using a transmission wire according to one embodiment of the invention;

FIG. 3 a schematic diagram of transmission between the mobile device and the embedded system in FIG. 1 using wireless transmission according to one embodiment of the invention;

FIG. 4 is a schematic diagram of a data output system according to another embodiment of the invention;

FIG. 5 is a schematic diagram showing an example of the converting circuit in FIG. 4;

FIG. 6 is a schematic diagram of transmission between the mobile device and the embedded system in FIG. 4 using a transmission wire according to one embodiment of the invention; and

FIG. 7 is a schematic diagram of transmission between the mobile device and the embedded system in FIG. 4 using wireless transmission according to one embodiment of the invention.

### DETAILED DESCRIPTION OF THE PREFERRED EMBODIMENT

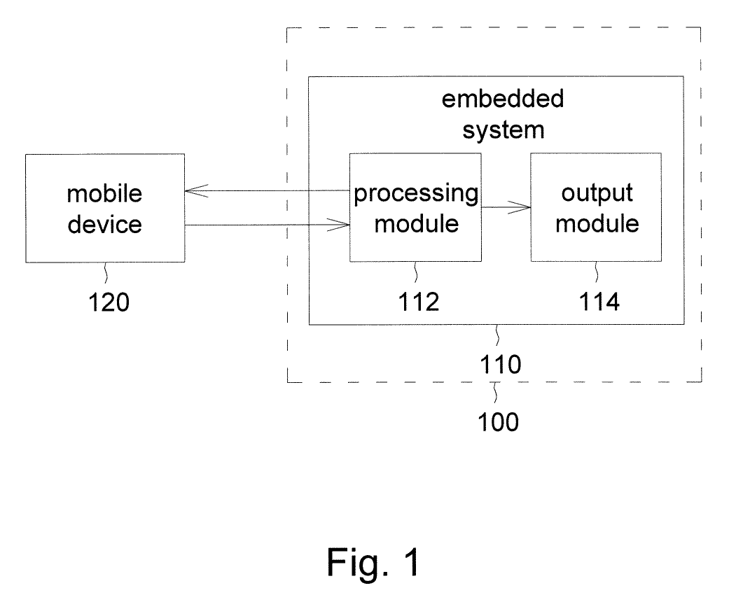

FIG. 1 shows a data output system 100 according to one embodiment of the invention. The data output system 100 comprises an embedded system 110 for processing and outputting data of a mobile device 120. More specifically, the embedded system 110 processes data transmitted from the mobile device 120 using a processing module 112, and transmits the processed data to an output module 114 for output. Through the data output system 100, digital data of display data or image files stored are transferred to the output module 114 of the embedded system 110 for output.

The embedded system 110 may be a television, a portable navigation device (PND), or a mobile entertainment device having a screen. The processing module 112 may be a central processing unit (CPU), while the output module 114 may be a display screen of the embedded system 110. The embedded system 110 is operable under several modes, e.g., a function mode built in the embedded system 110 and a special display mode for displaying data transmitted from the mobile device 120. Taking a television for example, the television has at least a television mode for playing television programs and a special display mode. Switching between the modes may be triggered by a control interface of the embedded system 110, or by a control signal outputted from the mobile device 120 to the processing module 112.

The digital data transmitted from the mobile device 120 to the processing module 112 comprises display data of a user interface (UI) of the mobile device 12, audio signals, and control signals, e.g., for switching between the modes of the embedded system 110. Further, when the processed digital data from the processing module 112 is outputted by the output module 114, the embedded system 110 feeds back a control signal to the mobile device 120 to control operations of the mobile device 120, so that the embedded system 110 also serves as a control interface of the mobile device 120. When the foregoing architecture is implemented for a cell phone and an in-car navigation system, the in-car navigation system provides a navigation map and driving information when on-route, and switches to a special display mode when the cell phone rings for an incoming call. Under the special display mode, a display screen of the navigation device shows the number and caller of the incoming call. The user may further transmit a control signal for answering the phone call via the navigation device to the cell phone, and utilize a speaker of the navigation device for carrying out the call under a speaker mode.

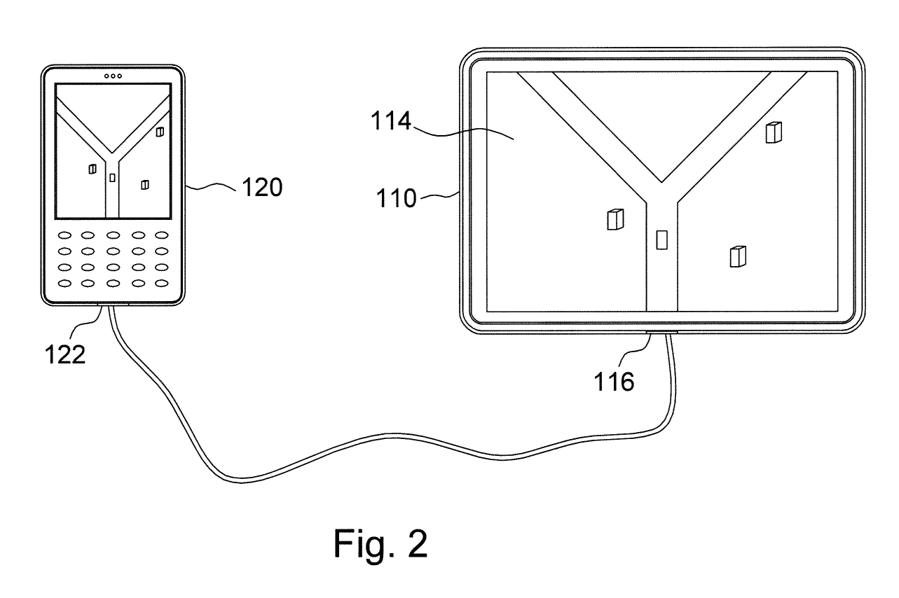

Data transmission between the mobile device 120 and the embedded system 110 may be accomplished using a transmission wire, as shown in FIG. 2. FIG. 2 shows an example of a cell phone and a PND respectively implemented as the mobile device 120 and the embedded system 110. The cell phone 120 and the PND 110 respectively comprise connecting ports 122 and 116. Via the connecting port 116, the processing module 112 of the PND 110 is coupled to the connecting port 122 of the cell phone 120 using the transmission wire. The connecting ports 122 and 116 adopt a same transmission interface, e.g., an RS232 COM port interface or a Universal Serial Bus (USB) interface. For a cell phone using the Windows Mobile™, the cell phone includes software for Remote Desktop Service™, so that data stored in a frame buffer of the cell phone is first dumped to a Universal Asynchronous Receiver/Transmitter (UART) and then transmitted via the connecting port 122. Thus, by simply connecting the respective connecting ports 122 and 116 of the cell phone 120 and the PND 110, the display screen of the cell phone 120 is transmitted to the PND 110, processed by the processing module 112 and then displayed on the screen 114. For example, a navigation function of the cell phone 120 is displayed on the large screen 114 of the PND 110.

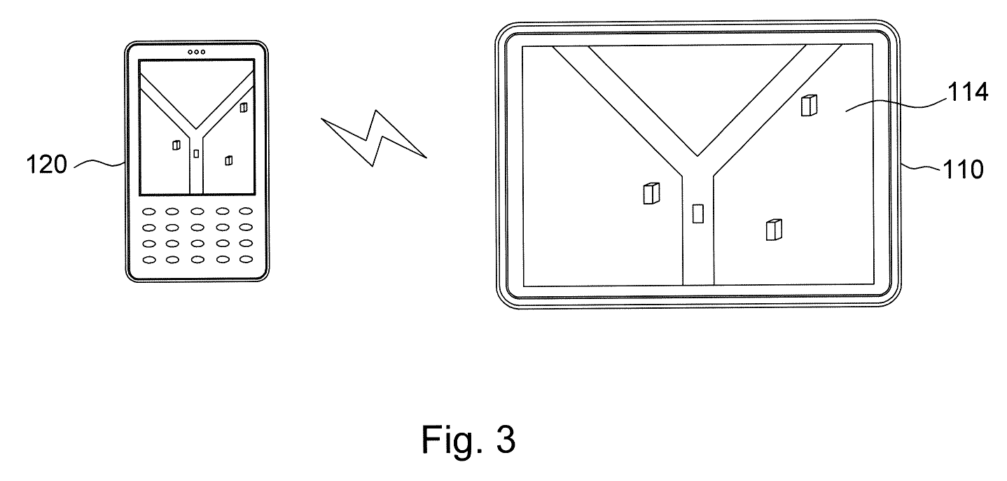

Further, when the mobile device 120 and the embedded system 110 both have wireless transmission capabilities, data transmission may also be carried out using wireless transmission, as shown in FIG. 3. In one embodiment, the cell phone 120 transmits audio signals via Bluetooth to the embedded system 110, which may provide a function similar to Bluetooth earphones.

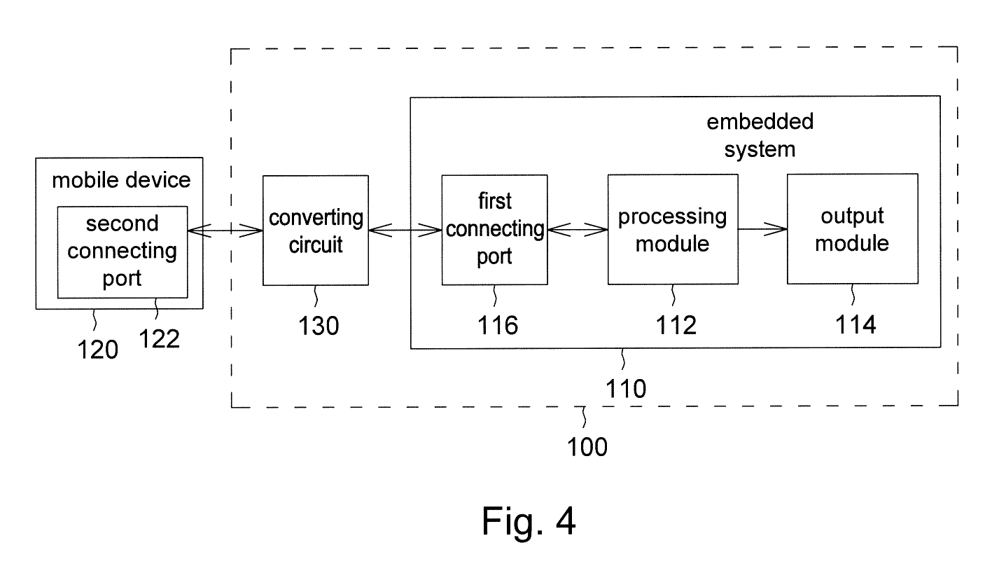

FIG. 4 shows the data output system 100 according to another embodiment of the invention. In this embodiment, the data output system 100 further comprises a converting circuit 130 coupled between the connecting port 116 of the embedded system 110 and the connecting port 122 of the mobile device 120. When different transmission interfaces are adopted by the embedded system 110 and the mobile device 120, the converting circuit 130 converts data transmission specifications between the embedded system 110 and the mobile device 120. For example, the converting circuit 130 converts data outputted from the mobile device 120 into a format compliant with data transmission specifications of the connecting port 116, or converts data (e.g., signals of the control interface) outputted from the embedded system 110 into a format compliant with data transmission specifications of the connecting port 122.

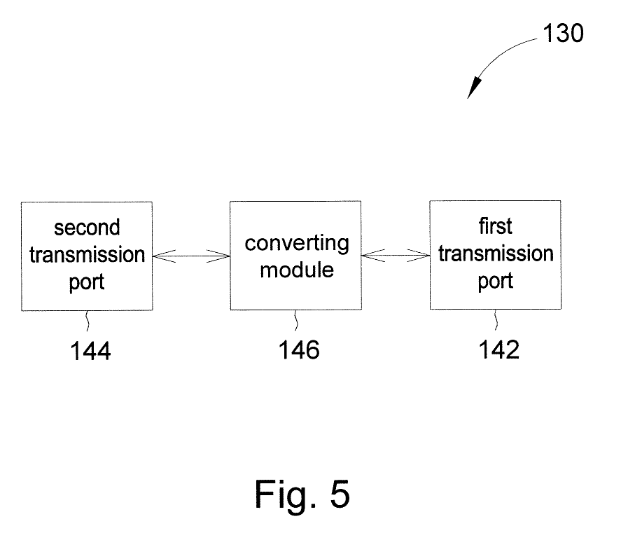

Referring to FIG. 5, the converting circuit 130 comprises a first transmission port 142, a second transmission port 144 and a converting module 146. The first transmission port 142 is designed to be compatible with the connecting port 116, and the second transmission port 144 is designed to be compatible with the connecting port 122. Therefore, when the first transmission port 142 is electrically connected to the connecting port 122 of the mobile device 120, the converting module 146 is allowed to dump data stored in the frame buffer via the connecting port 122 and the second transmission port 144. The converting module 146 further converts the data into a data format compliant to the embedded system 110. The converted data is transmitted to the processing module 112 via the first transmission port 142 and the connecting port 116, received and processed by the processing module 112, with the processed data finally displayed on the output module 114.

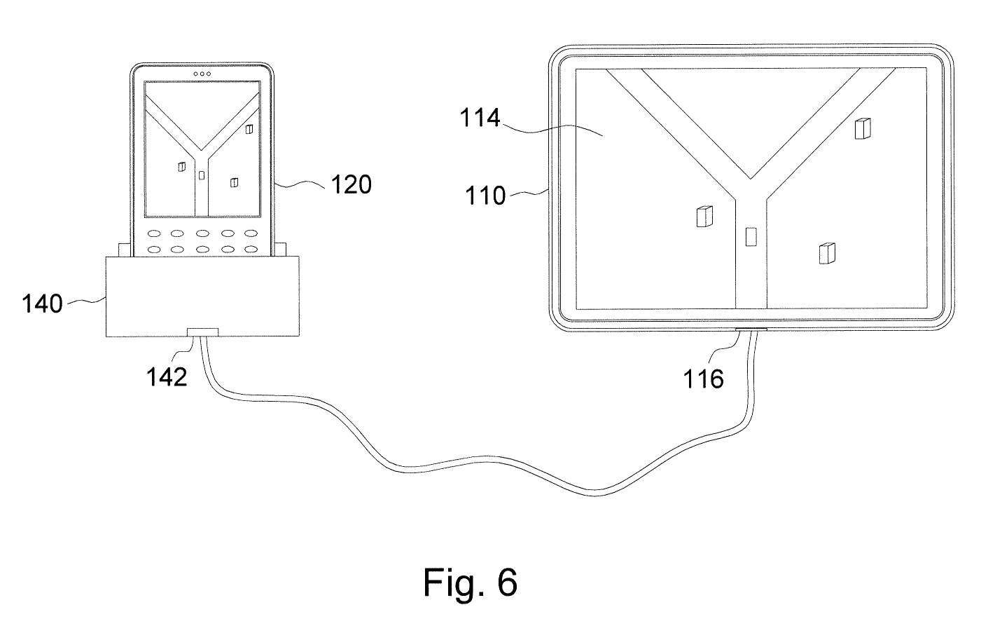

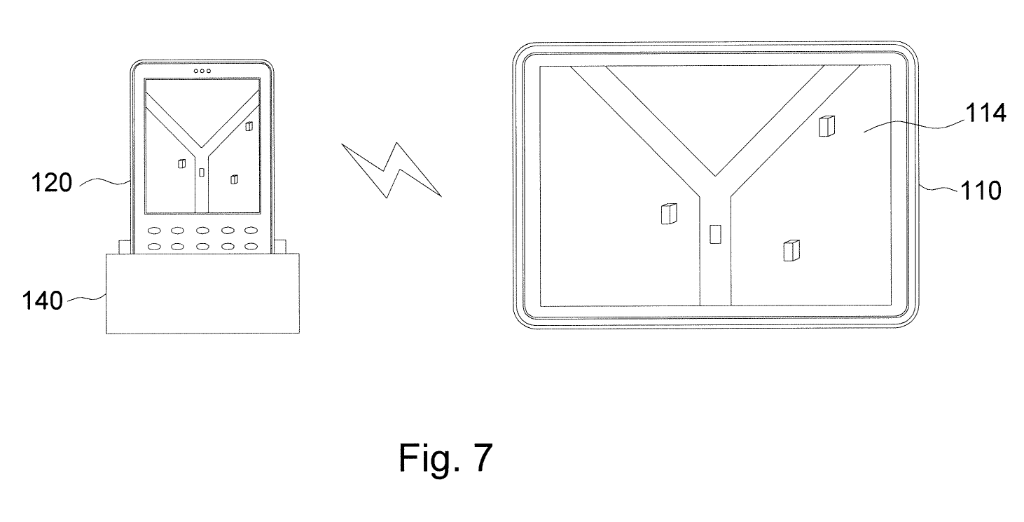

The converting circuit 130 may be realized using a connector, or be provided in a socket 140, as shown in FIG. 6. In the embodiment shown in FIG. 6, the second transmission port 144 is a slot (not shown) coupled to the connecting port 122 of the mobile device 120, and the first transmission port 142 is connected to the connecting port 116 of the embedded system 110 via a transmission wire. The first transmission port 142 and the second transmission port 144 may also be designed as wireless transmission interfaces. Supposing the first transmission port 142 includes a wireless transmission interface, the socket 140 and the embedded system 110 may perform wireless transmission as shown in FIG. 7. For example, transmission is carried out between the socket 140 and the embedded system 110 via Bluetooth, or the socket 140 and the embedded system 110 are first linked using wireless interfaces such as Wi-Fi to further perform data transmission.

Therefore, according to the invention, display data of the mobile device 120 may be displayed on the output module 114 of the embedded system 110, and a user may further interact with the mobile device 120 using the embedded system 110 as a control interface. Taking a cell phone for example, a display screen of the cell phone is displayed on the screen 114 of the embedded system 110, e.g., an in-car PND. As a result, a user may view functions such as navigation maps, call details and the calendar with a to-do list, or may simply use the embedded system 110 as a telephone interface, to accomplish effects of providing a clear display and enhancing driving safety.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. A data output system, for externally connecting to a mobile device, comprising:
an embedded system, comprising:
an output module; and
a processing module, coupled to the output module, for processing digital data transmitted from the mobile device and sending resulting processed digital data to the output module for output.

2. The data output system as claimed in claim 1, wherein the digital data transmitted from the mobile device comprises a display data, an audio signal or a control signal of a user interface of the mobile device.

3. The data output system as claimed in claim 1, wherein the embedded system further serves as a control interface of the mobile device, and the processing module further feeds back a control signal to the mobile device to control operations of the mobile device when the output module outputs the processed digital data.

4. The data output system as claimed in claim 1, wherein the embedded system further comprises a first connecting port, via which the processing module is coupled to a second connecting port of the mobile device using a transmission wire.

5. The data output system as claimed in claim 4, further comprising a converting circuit, coupled between the first connecting port and the second connecting port of the mobile device, for converting data transmission specifications between the embedded system and the mobile device.

6. The data output system as claimed in claim 1, wherein the processing module receives the digital data from the mobile device via wireless transmission.

7. The data output system as claimed in claim 6, further comprising:
a converting circuit, having a wireless transmission interface, coupled to a second connecting port of the mobile device, for performing wireless transmission with the embedded system to transmit the digital data to the processing module.

8. A method for outputting data of a mobile device, comprising steps of:
transmitting digital data of the mobile device to an embedded system; and
processing the digital data using the embedded system, and outputting resulting processed digital data using an output module of the embedded system.

9. The method as claimed in claim 8, wherein the digital data comprises display data, an audio signal or a control signal of a user interface of the mobile device.

10. The method as claimed in claim 8, the embedded system further serving as a control interface of the mobile device, the method further comprising a step of:
feeding back a control signal to the mobile device to control operations of the mobile device when the output module outputs the processed digital data.

11. The method as claimed in claim 8, wherein the embedded system further comprises a first connecting port, and the step of transmitting the digital data of the mobile device to the embedded system comprises steps of:
coupling a second connecting port of the mobile device and the first connecting port of the embedded system using a transmission wire; and
transmitting the digital data via the transmission wire to the embedded system.

12. The method as claimed in claim 11, wherein the step of transmitting the digital data via the transmission wire to the embedded system comprises a step of:
converting data transmission specifications between the embedded system and the mobile device.

13. The method as claimed in claim 8, wherein the step of transmitting the digital data via the transmission wire to the embedded system comprises transmitting the digital data via a wireless transmission interface to the embedded system.

14. The method as claimed in claim 13, wherein the step of transmitting the digital data via the transmission wire to the embedded system comprises a step of:
converting data transmission specifications between the embedded system and the mobile device, and performing wireless transmission with the embedded system using the wireless transmission interface.
